(19) United States
(12) Patent Application Publication
(10) Pub. No.: US 2007/0067721 A1
(43) Pub. Date: Mar. 22, 2007

(54) Method and system for navigation in text according to the properties of the text

(75) Inventors: Shmuel UR, Haifa (IL); Aviad Zlotnick, Haifa (IL)

Correspondence Address: Stephen C. Kaufman;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 11/229,986

(22) Filed: Sep. 19, 2005

(51) Int. Cl. G06F 17/00

(52) U.S. Cl. 715/700; 715/764

(57) ABSTRACT

A computer-implemented method for navigating a location marker in text, the method includes moving a location maker from one location in a text to another location in the text according to properties of the locations. The movements of the location maker further includes executing a command to move the location maker from one location in the text, the command is related to at least one property of said text. Then, responsive to the command, another location in said text with at least one property of text indicated by the command is searched, and the location marker is moved to the other location in the text found during the search.

### FIELD OF THE INVENTION

The present invention relates generally to the field of computing methodologies. In particular, the present invention relates to document and text editing, and more specifically, to a method and system for navigation in text according to the properties of the text.

### BACKGROUND OF THE INVENTION

Text editors, word processors, office suites applications and document viewers (collectively referred as “text editors” hereinafter) are widely used almost in any interaction with a computer. Programmers use them to prepare, modify and view program source codes, authors use them to create, edit and view the text files they write, web site developers use them to build and develop web sites, etc.

Text editors provide their users with a range of tools. Typically these include find and replace functions, copy and paste facilities, navigation facilities, and text or syntax highlighting (i.e., the editor recognizes the syntax of a given programming or markup language and applies color coding accordingly to make it easier to identify different features of the language and, in the case of markup, to separate the tags from the body or content of text).

Some, more sophisticated, text editors, such as but not limited to Emacs or VI, offer more sophisticated navigation facilities that enable their user to move from one location in the text to another easily and quickly. They typically provide commands and keystroke combinations that allow the user to move within the text and to edit the text using only the keyboard and without using additional I/O devices such as the mouse. An exemplary set of commands that enable movement within the text and editing it in VI editor is provided in http://www.tux.org/˜sheafer/vi.html.

### SUMMARY OF THE INVENTION

There is provided, in accordance with an embodiment of the present invention, a computer-implemented method for navigating a location marker in text, the method includes moving a location marker from one location in a text to another location in the text according to properties of the locations.

According to this embodiment the movement of the location marker further includes executing a command to move the location marker from one location in said text, the command is related to at least one property of said text. Then, responsive to the command, another location in the text with at least one property of text indicated by the command is searched, and the location marker is moved to the other location in the text found during the search.

Also provided in accordance with another embodiment of the present invention, a system for navigating a location marker within a text, the system includes a text editor to enable a user to edit a text having plain text and a plurality of properties coupled to the text; and a processor to move a location marker from one location in the text to another location in the text according to properties of these locations.

Embodiments of the present invention also provide and computer software product implementing the above method.

### BRIEF DESCRIPTION OF THE DRAWINGS

Embodiments of the present invention will now be described, by way of examples only, with reference to the accompanying drawings in which:

FIG. 1 is an exemplary illustration of text that is being navigated in accordance with embodiments of the present invention; and

FIG. 2 is a flow chart illustration of a method for navigating in text according to the properties of the text, in accordance with embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DESCRIPTION OF EMBODIMENTS OF THE PRESENT INVENTION

Applicants have realized that text editors provide movement commands that are related to simple monochrome text, without taking into account the properties of the text. Navigating or moving within a text according to the properties of the text, as will be described in detail hereinbelow, may increase the efficiency and usability of editing tasks.

In order to better understand embodiments of the present invention, it should be noted that applicants have further realized that text that is edited in text editors may be described in two levels. The first level relates to the plain text that is edited, e.g., the sequence of characters from a markup language's document character set that are interpreted in ASCII or some similar format. The second level relates to the properties of the text. For the purpose of this invention the term “text properties” will be used hereinafter to describe characteristics related to the text that may be used to present the text (hereinafter “formatting properties”) and other characteristics also related to the text that may be used to understand the context of the text (hereinafter “context properties”).

Formatting properties may include, for example, formatting functions like the font of the text, its size, color, and style. These characteristics may also be considered as text attributes, which may be represented as the control codes that are attached to the text.

Context properties may include, for example, the direction or alignment of the text, whether the text is used a link to other documents, etc. In some cases the context of the text may also include the language of the text.

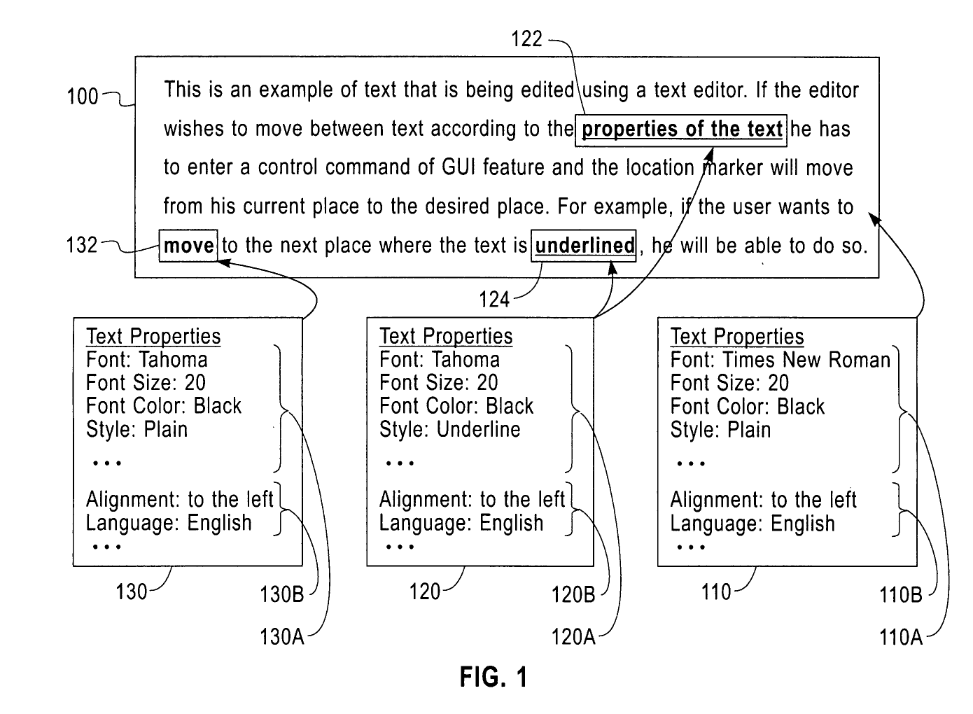

Reference is now made to FIG. 1 which is an exemplary illustration of text 100 that is being navigated in accordance with embodiments of the present invention. Text 100 may be edited by a text editor, such as but not limited to Word, Wordpad, Notepad, commercially available from Microsoft Corporation of the USA, and Word Pro, commercially available from International Business Machines Corporation of the USA, that are widely utilized by users of Microsoft Windows operating system. Text 100 may also be edited by Edit in MS-DOS, SimpleText for Macintosh, commercially available from Apple Computer, Inc., or NEdit, JEdit, Emacs, or VI for the UNIX operating system. It should be noted that the text 100 may be edited by any text editor that provides navigation tools within the edited text.

As shown in FIG. 1, most of the text 100 has the same text properties 110, except for the words “properties of the text” 122 and “underlined” 124, that have a different set of text properties 120, and the word “move” 132, that has a further different set of text properties 130.

According to some embodiments of the present invention, a user of the text editor may navigate from the words “properties of the text” 122 to “underlined” 124 by entering a command or using a graphical user interface (GUI) feature that will result in moving a location marker from the words “properties of the text” to “underlined”. Alternatively or additionally, the user of the text editor may navigate from the words “properties of the text” 122 to “move” 132, and further to “underlined” 124 by entering a different command or using a different GUI feature that will result in moving the location marker from the words “properties of the text” 122 to “move” 132, and further to “underlined” 124.

For the purposes of this invention, the term “location marker” will be used hereinafter to describe a movable symbol on a display or a text area, typically a blinking or solid block of light, that is typically used to identify a choice to select, indicate where user interaction with the keyboard will appear, or indicate a position of interest on the display surface or text area.

In the example of the formatting properties 120A of most of the text 100, the text is presented in Times New Roman serif typeface, its size is 20 points, the color of the text is black, and its style is plain. The formatting properties 120A of the text “properties of the text” 122 and “underlined” 124 differ from the formatting properties 110A in the type of the font (i.e. Tahoma), and in the style of the font, (i.e. underline). The formatting properties 130A of the text “move” 132 differ from the formatting properties 110A in the type of the font which is Tahoma. As described above, according to embodiments of the present invention, a user of text editor may navigate from the words “properties of the text” 122 to “underlined” 124. Alternatively or additionally, the user may navigate from the words “properties of the text” 122 to “move” 132, and further to “underlined” 124.

It should be noted that the formatting properties 110A, 120A, and 130A that are provided in FIG. 1 are provided only as an example. Additional text properties, such as but not limited to the background of the font, effects of the font (strikethrough, superscript, subscript, etc.), and other properties or attributes that are related to the way the font is displayed on the screen and printed, e.g., scaling of the font, the position of the text related to a baseline, etc., may be applicable as well.

As mentioned above, a second set of the characteristics or properties may be used to understand the context of the text. The context properties may include, for example, the direction or alignment of the text, whether the text is used a link to other documents, etc. In some cases the context properties may also include the language of the text. In the example of FIG. 1, in context properties 110B, 120B and 130B, the text is aligned to the left and its language is English. In accordance with some embodiments of the present invention, a user of text editor may navigate from text written in a specific language, e.g., Hebrew, or in a specific character set, to the next place in the text where that language or character set is used, by entering a command or using a GUI feature.

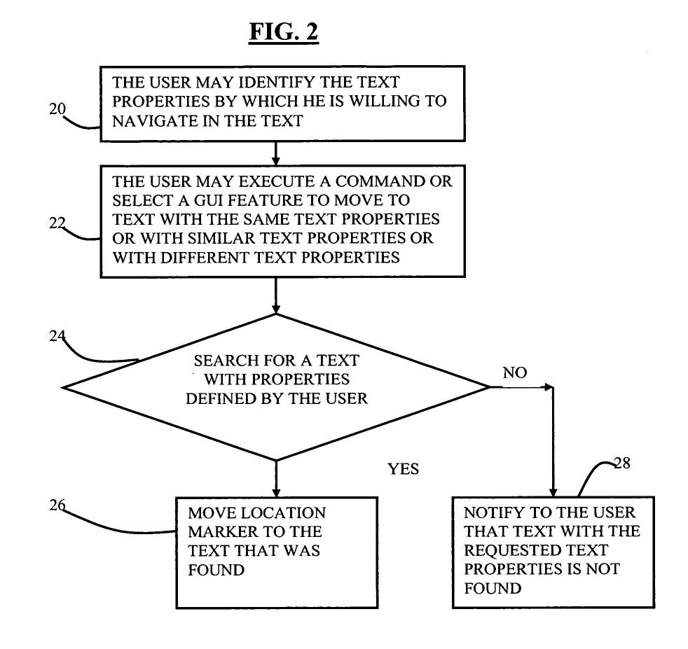

Reference is now made to FIG. 2 which is a flow chart illustration of a method for navigating in text according to the properties of the text, in accordance with embodiments of the present invention. The user may identify (step 20) the text properties by which he is willing to navigate in the text. The user may execute (step 22) a command or select a GUI feature to move to text with the same text properties, or with a subset of the text properties of the text that the user is currently editing, or to text that differs from the current text by any text property.

For example, referring back to FIG. 1, the user may want to move, for example, from one underlined text, e.g., “properties of the text” 122 to text with the same text properties, i.e., to the text “underlined” 124, both have the same text properties 120.

Alternatively, the user may want to move from text with certain text properties, e.g., “properties of the text” 122, to text with similar subset of the text properties, e.g., with some properties that are the same. Accordingly, the user may move from the text “properties of the text” 122 to the text “move” 132, both have the same text properties except the style of the font which is underline in the first and plain in the latter.

Still alternatively, the user may want to move from the text “this is an example” (the first words of text 100) to text that differs from it by any text property. Accordingly, the user may move from text “this is an example” to the text “properties of the text” 122, which is bolded, underlined, and has a different font.

It should be noted that a command may be formulated to look for the previous text with the same text properties or a subset of the text properties. It may also be formulated to look for the next N or previous N texts with the same text properties or a subset of the text properties.

In accordance with embodiments of the present invention, responsive to the command entered by the user, a search may be performed (step 24) for a text having the properties defined by the user. The search may be done, for example, by searching for control codes, which define text properties, that may be attached to the text. When the text with the requested properties is found, the location marker may move (at step 26) to the new text. If text with the requested properties is not found, the user may be notified (notification step 28) that text with the requested text properties is not found.

For example, when a user is interested to move to the next place in the text being edited that is underlined, he may enter a command or select a GUI feature to move to the next underlined place in the text. Accordingly, responsive to the command entered by the user, a search may be performed for an underlined text. When the text with the requested properties is found, i.e., underlined text, the location marker may move to the underlined text. If text with the requested properties is not found, the user may be notified that no underlined text is found in the text being edited.

In the description above, numerous specific details were set forth in order to provide a thorough understanding of the present invention. It will be apparent to one skilled in the art, however, that the present invention may be practiced without these specific details. In other instances, well-known circuits, control logic, and the details of computer program instructions for conventional algorithms and processes have not been shown in detail in order not to obscure the present invention unnecessarily.

Software programming code that embodies aspects of the present invention is typically maintained in permanent storage, such as a computer readable medium. In a client-server environment, such software programming code may be stored on a client or server. The software programming code may be embodied on any of a variety of known media for use with a data processing system. This includes, but is not limited to, magnetic and optical storage devices such as disk drives, magnetic tape, compact discs (CD's), digital video discs (DVD's), and computer instruction signals embodied in a transmission medium with or without a carrier wave upon which the signals are modulated. For example, the transmission medium may include a communications network, such as the Internet. In addition, while the invention may be embodied in computer software, the functions necessary to implement the invention may alternatively be embodied in part or in whole using hardware components such as application-specific integrated circuits or other hardware, or some combination of hardware components and software.

The present invention is typically implemented as a computer program product, comprising a set of program instructions for controlling a computer or similar device. These instructions can be supplied preloaded into a system or recorded on a storage medium such as a CD-ROM, or made available for downloading over a network such as the Internet or a mobile telephone network.

Improvements and modifications can be made to the foregoing without departing from the scope of the present invention.

It will be appreciated by person skilled in the art that the present invention is not limited to what has been particularly shown and described hereinabove. Rather, the scope of the present invention includes both combinations and sub-combinations of the various features described hereinabove, as well as variations and modifications thereof that are not in the prior art, which would occur to persons skilled in the art upon reading the foregoing description.

1. A computer-implemented method for navigating a location marker in text, the method comprising:
moving a location marker from one location in a text to another location in said text according to properties of said locations.

2. The method according to claim 1, wherein said moving further comprising:
executing a command to move said location marker from said one location in said text, said command is related to at least one property of said text;
responsive to said command, searching said another location in said text with at least one property of text indicated by said command; and
moving said location marker to said another location in said text found during said searching.

3. The method according to claim 2, wherein said at least one property is used to present said text.

4. The method according to claim 3, wherein said at least one property is a formatting property.

5. The method according to claim 4, wherein said formatting property is one of the following properties: the font of the text, the size of the font, the color, the style, the background of the font, the effects of the font, scaling of the font, and the position of the text related to a baseline.

6. The method according to claim 2, wherein said at least one property is a context property.

7. The method according to claim 6, wherein said context property is one of the following properties: alignment of the text, and language of the text.

8. The method according to claim 2, wherein said executing further comprises looking for text with the same text properties of the text where said command is being executed.

9. The method according to claim 2, wherein said executing further comprises looking for text with a subset of the text properties of the text where said command is being executed.

10. The method according to claim 2, wherein said executing further comprises looking for text with different text properties than the text where said command is being executed.

11. A system for navigating a location marker within a text, the system comprising:
a text editor to enable a user to edit a text having plain text and a plurality of properties coupled to said text; and
a processor to move a location marker from one location in said text to another location in said text according to properties of said locations.

12. The system according to claim 11, wherein at least one of said plurality of properties is a formatting property.

13. The system according to claim 11, wherein at least one of said plurality of properties is a context property.

14. The system according to claim 11, wherein said processor further executes said command to look for text with the same text properties of the text where said command is being executed.

15. The system according to claim 11, wherein said processor further executes said command to look for text with a subset of the text properties of the text where said command is being executed.

16. The system according to claim 11, wherein said processor further executes said command to look for text with different text properties than the text where said command is being executed.

17. A computer software product, including a computer-readable medium in which computer program instructions are stored, which instructions, when read by a computer, cause the computer to perform a method of navigating a location marker in text, the method comprising:
moving a location marker from one location in a text to another location in said text according to properties of said locations.

18. The product according to claim 17, wherein said moving further comprising:
executing a command to move said location marker from said one location in said text, said command is related to at least one property of said text;
responsive to said command, searching said another location is said text with at least one property of text indicated by said command; and
moving said location marker to said another location in said text found during said searching.

19. The product according to claim 17, wherein said at least one property is used to present said text.

20. The product according to claim 17, wherein wherein said another location has the same, subset, different text properties from said first location.
